(19) United States
(12) Patent Application Publication
(10) Pub. No.: US 2025/0158496 A1
(43) Pub. Date: May 15, 2025

(54) METHOD FOR PRODUCING A FLUX-ORIENTED MULTIPOLE MAGNET

(71) Applicant: SAFRAN, Paris (FR)

(72) Inventors: Benjamin DAGUSE, MOISSY-CRAMAYEL (FR); Sabrina Siham AYAT, MOISSY-CRAMAYEL (FR); Pierre Jean SALLOT, MOISSY-CRAMAYEL (FR)

(73) Assignee: SAFRAN, Paris (FR)

(21) Appl. No.: 18/837,947

(22) PCT Filed: Feb. 8, 2023
(86) PCT No.: PCT/FR2023/050170

§ 371 Date: Aug. 13, 2024

(30) Foreign Application Priority Data
Feb. 18, 2022 (FR) 2201438

(51) Int. Cl. H02K 15/038; B22F 3/105

(52) U.S. Cl. CPC H02K 15/038; B22F 3/105; B22F 2003/1051; B22F 2202/05

(57) ABSTRACT

A method for producing a magnet for a rotor of an electric machine has a first phase of producing a magnet blank which includes a step of pressing powders into a magnet mold in the presence of a magnetic field while subjecting the powders to a magnetic field generated by a first magnetization tool. The method further includes a step of densifying the obtained magnet blank and a second phase. The second phase includes finishing the magnet blank by at least one final magnetization step in order to obtain a magnet. The mold is arranged in a densifying chamber, and the densifying step is carried out by flash SPS sintering in the densifying chamber.

### TECHNICAL FIELD OF THE INVENTION

The invention relates to a method for producing a magnet, and in particular a multipole magnet with oriented flux for a rotor of an electric machine such as an electric motor, generator or sensor, and to a tool allowing to implement this method.

### TECHNICAL BACKGROUND

The prior art comprises the documents DE-10/2015-006916-A1 and US-2017/170695-A1.

There are two types of magnet, the unidirectional magnets, which have a unidirectional orientation between their two North and South poles, and variable orientation magnets, which have a continuously variable orientation between their two North and South poles.

The latter have asymmetrical field lines on either side of the magnet, and are therefore referred to as oriented flux magnets because the fields they generate are stronger on one side of the magnet than on the other in relation to the North/South orientation.

This property is of particular interest in the production of multipole annular magnets. These magnets allow to limit magnetic leakage when used in electric machines.

For example, a multipolar annular magnet with oriented flux forms a so-called Halbach magnet array, which has the advantage of increasing the magnetic field on one side of the magnet while almost completely eliminating the magnetic field on the other side.

When such a magnet is used in the rotor of an electric machine, this configuration allows to provide field lines that are mainly oriented towards the outside of the rotor, i.e. towards its stator, with a magnetic field that is generally stronger, and field lines that are virtually non-existent towards the inside of the rotor. As a result, electric machines are more efficient than an electric machine using traditional magnets.

The magnetization of such magnets is well known in the prior art and is documented in the document WO-97/37362-A1.

As part of the production of an electric machine rotor, such a magnet also has the advantage of being one-part. In a conventional design using unidirectional magnets, it is necessary to glue a large number of these magnets to an annular support. Such an operation is not very advantageous in terms of producing time and cost, whereas a design implementing a one-part magnet allows to reduce producing time.

The document EP-3637060-A2 describes a method for producing such a magnet. Conventionally, such a method comprises a first step wherein materials are selected configured to provide metal magnet powders. These materials are melted in an induction furnace, then the ingots obtained undergo an initial grinding phase to obtain grain sizes close to 500 μm and, which are then pulverized by ball milling or pressurized gas jet milling to a size close to 10 μm.

This is followed by a second step wherein the powders are mixed, a third step wherein the powders are placed in a mold, and a fourth step wherein the powders are pressed at room temperature while being subjected to a magnetic field generated by a first magnetization tool.

Then, in a fifth step, the magnetic field generated by the first magnetization tool is stopped, and in a sixth step, the magnet blank thus obtained is densified by a conventional sintering method. This blank may then be machined in a seventh step and finally magnetized in an eighth, final magnetization step.

This method has a number of disadvantages.

Firstly, this method is limited to obtaining simple shapes that are easy to remove from the mold.

Secondly, the steps of pressing at room temperature, densifying and final magnetization are dissociated and generally carried out in independent tools, which increases the complexity of the production range and leads to long producing times. It also leads to the problem of repositioning the magnet blank to be magnetized between the different steps, in order to reinforce the final magnetic field of the magnet, since during the eighth final magnetization step, the blank must be oriented in the same position as during the fourth step. This point is all the more critical for Shaped Field magnets, where the angular gap between the cold magnetization step and after densification must be minimized.

Thirdly, the densifying step is very often carried out without the blank being held under pressure, in what is known as “free sintering”, which requires significant densification times and temperatures to achieve high densification levels of over 90%.

Finally, the cold magnetization steps require a lot of energy to saturate the material, and therefore high-capacity magnetization tools, which is limiting in the case of creating a rotating field because the total energy consumed is distributed over a wide range of angular domains of the field, with the result that the amplitude of the field is reduced for each orientation.

There is therefore a real need for a producing method that may produce a multipole oriented flux magnet in a reduced number of steps.

### SUMMARY OF THE INVENTION

The invention remedies these disadvantages by proposing a new producing method wherein the pressing at ambient temperature and densifying steps are carried out in the same tool and wherein the densifying step is carried out by flash SPS sintering (Spark Plasma Sintering), or arc plasma sintering.

To this end, the invention proposes a method for producing a magnet for a rotor of an electric machine, said method comprising a first phase of producing a magnet blank comprising:
a first step during which metal and/or ceramic magnet powders are supplied,
a second step during which said powders are mixed,
a third step during which said powders are placed in a mold and a first magnetization tool is placed around said mold,
a fourth step of pressing under a magnetic field, during which said powders are pressed at room temperature to obtain the magnet blank, and are simultaneously subjected to a magnetic field generated by the first magnetization tool,
a fifth step during which the magnetic field generated by the first magnetization tool is stopped, and
a sixth step during which the magnet blank is densified,
said method further comprising a second phase for finishing the magnet blank comprising at least one step of machining the magnet blank and a step of final magnetization of the magnet blank, to obtain the magnet, characterized in that, during the third step, the mold is placed in a densifying chamber, in that the sixth step is carried out by flash SPS sintering in said densifying chamber.

In this way, the method described in the invention allows the room temperature pressing and densifying steps to be carried out in the same tool, which eliminates transfer times from one tool to another and angular positioning errors. In addition, carrying out the densifying step by flash SPS sintering substantially allows to reduce the duration of this step, as it is no longer necessary to carry out a long temperature rise in the chamber wherein the densification is carried out.

According to another characteristic of the method, the second phase of finishing the magnet blank comprises, according to a first variant:
a seventh step during which the magnet blank is allowed to cool to the Curie temperature of the magnet,
an eighth step forming the final magnetization step during which the magnet blank is again subjected to a magnetic field generated by the first magnetization tool, and
a ninth step of machining the magnet blank out of the mold, at the end of which the magnet is obtained.

In this first variant, the pressing at ambient temperature, densifying and magnetization steps are advantageously all carried out in the same tool, which allows to save a substantial amount of time and reduces the number of tools involved.

The eighth densifying step, which is carried out while the magnet blank is cooling while still at a temperature close to its Curie temperature, also allows to magnetize the material strongly while limiting the energy consumed by the first magnetization tool, because the orientation of the magnetic domains or Weiss domains in the material is easier to achieve and less energy-consuming at a temperature close to the Curie temperature.

According to another characteristic of the method, the second phase of finishing the magnet blank comprises, according to a second variant:
a seventh step of machining the magnet blank out of the mold,
an eighth step during which the magnet blank is arranged in a second magnetization tool independent of the mold in an orientation similar to a position occupied by the magnet blank in the first magnetization tool at the end of the fourth step, and
a ninth step forming the final magnetization step during which the magnet blank is again subjected to a magnetic field generated by the second magnetization tool independent of the mold.

In this second variant, the pressing at room temperature and densifying steps are advantageously carried out in the same tool, which allows to save a substantial amount of time and reduces the number of tools involved. The magnetization step is carried out in a second magnetization tool independent of the mold. This allows to free up the mold to prepare another magnet.

According to another characteristic of the method, in the second phase of finishing the magnet blank, according to a third variant, the ninth magnetization step may also be carried out in a second magnetization tool independent of the mold, consisting of a stator of an electric machine configured to receive the magnet. This ninth magnetization step (ET′9) is therefore an in situ magnetization.

Another characteristic of the method is that during the fourth step of pressing under a magnetic field, the powders are pressed under an increasing pressure of less than 100 MPa.

Another characteristic of the method is that in the sixth step, the powder is densified by rapidly raising its temperature to between 90° and 1200° C.

The invention also relates to a device for implementing the producing method of the type described above, which comprises at least:
a metal mold comprising a stationary matrix delimiting a cavity and at least one punch which is complementary to a section of the cavity, and which is moved by a hydraulic press between a position outside the cavity and a position wherein it closes the cavity and penetrates into said cavity along a determined path,
a flash SPS sintering tool comprising at least one pulsed current generator, current conducting means arranged in said matrix and said punch, and a chamber containing the mold capable of being selectively evacuated or filled with a neutral gas, and
a first magnetization tool, comprising an annular magnetic circuit housed in the chamber and surrounding the mold.

Other characteristics of the device comprise:
the device also comprises an annular heat shield interposed between the mold and the magnetic circuit,
the device also comprises an annular cooling exchanger arranged around the magnetic circuit inside the chamber,
the device is configured for the production of a multipolar annular magnet with a flux oriented along the axis X, and:
   the cavity of the mold is annular with axis X,
   the annular magnetic circuit of the first magnetization tool comprises a substantially annular magnetic core traversed along axis X by a plurality of magnetic coils having axes parallel to the axis X and distributed angularly in a regular manner around said axis X.
the magnetic core is traversed by a number of magnetic coils of between 4 and 16, and preferably between 8 and 16,
the mold is made of graphite or based on tungsten carbides or ternary carbides,
the current conducting means are graphite conductors.

The invention also relates to an installation for producing a multipolar annular magnet with flux oriented along the axis X in accordance with the second and third variants of the producing method described above, characterized in that it comprises a producing device and a second magnetization tool external to said producing device and of similar configuration to the first magnetization tool, able to surround the magnet blank.

According to another characteristic of this producing installation, the second magnetization tool is a stator of an electric machine, a rotor of which is configured to receive the flux with oriented magnet.

### BRIEF DESCRIPTION OF THE FIGURES

Further characteristics and advantages of the invention will become apparent from the following detailed description, for the understanding of which reference is made to the attached drawings wherein:

FIG. 1 is a schematic cross-sectional view of a unidirectional magnet;

FIG. 2 is a schematic cross-sectional view of a magnet with variable orientation or oriented flux;

FIG. 3 is a perspective view of a conventional electric machine rotor ring comprising unidirectional magnets;

FIG. 4 is a perspective view of a rotor ring of an electric machine according to the invention, comprising multipolar magnets with oriented flux;

FIG. 5 is a schematic view of the steps in a conventional magnet producing method;

FIG. 6 is a schematic view of a producing device according to the invention;

FIG. 7 is an axial half-section view of a first producing device according to the invention;

FIG. 8 is a perspective view of a part of the first device in FIG. 7;

FIG. 9 is a perspective view of the part of the first device shown in FIG. 7;

FIG. 10 is a cross-sectional view of a second producing device according to the invention;

FIG. 11 is a developed view of the magnetic circuit of a first variant of the device shown in FIG. 10;

FIG. 12 is a developed view of the magnetic circuit of a second variant of the device shown in FIG. 10;

FIG. 13 is a block diagram illustrating the steps of a first variant of the producing method of the invention;

FIG. 14 is a block diagram illustrating the steps of second or third variants of the producing method of the invention,

### DETAILED DESCRIPTION OF THE INVENTION

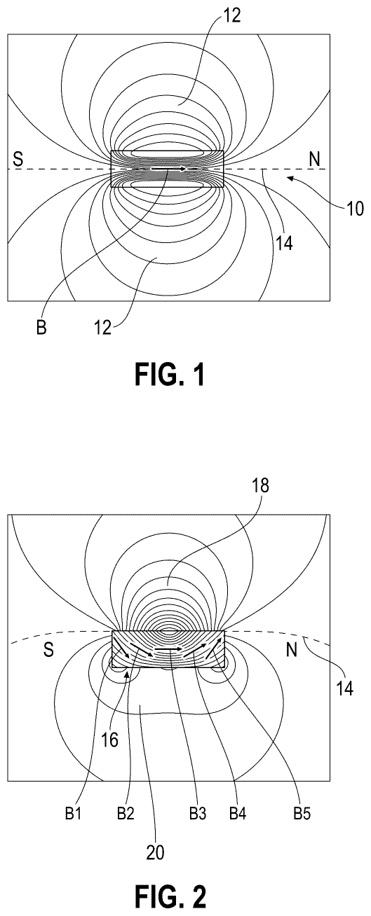

FIG. 1 schematically illustrates a straight unidirectional magnet 10 known per se from the prior art.

As illustrated by the arrow in FIG. 1, such a magnet has a unidirectional orientation of its magnetic field B between its two poles, North N and South S, and the field lines 12 generated by the magnet are distributed substantially symmetrically on either side of a North-South axis 14 of the magnet 10.

The magnets with a variable orientation, such as the magnet 16 shown in FIG. 2, have a variable orientation of their magnetic field, which may thus follow several directions similar to magnetic fields B1, B2, B3, B4, B5, etc., between their two poles, North N and South S, and continuously between their two poles, North N and South S.

The consequence for this type of magnet is that the field lines are not symmetrically distributed on both sides of the magnet 16. On one side of the North-South axis 14, the field lines 18 are very close together, indicating a strong magnetic field, whereas on the other side of the North-South axis 14, the field lines 18 are further apart, indicating a weaker magnetic field.

This property is particularly useful in the production of an annular magnet configured equip an electric motor. It is possible with such a magnet, during its production and in particular its magnetization, to maximize the magnetic field inside or outside this magnet, so as to reciprocally minimize the magnetic field, and therefore the magnetic losses, on the opposite side of the annular magnet, i.e. reciprocally outside or inside the annular magnet.

The invention relates more particularly to the production of an annular magnet for an electric machine rotor wherein the aim is to maximize the magnetic field outside the magnet in order to maximize the magnetic fields between the rotor and the stator of the electric machine surrounding the rotor. This allows to improve the efficiency of the electric machine comprising such an annular magnet.

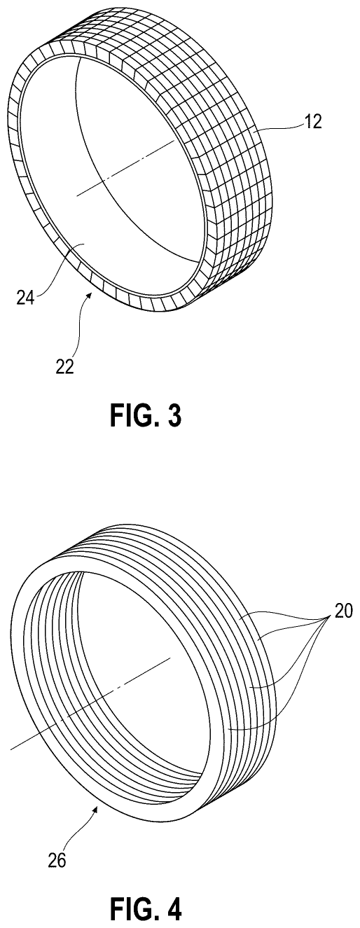

FIG. 3 shows an annular rotor 22 comprising a plurality of unidirectional magnets 12. Such a rotor 22 comprises an annular support 24 to which unidirectional magnets 12 are glued. For example, just under 400 magnets 12 need to be glued to the support 24. This is an extremely time-consuming operation, which does not result in a rotor 22 that delivers the best performance. In addition, there is always a risk that the magnets could become detached, causing irreversible damage to the electric motor.

In fact, another advantage of multipolar annular magnets with oriented flux, in addition to the efficiency they allow the electric machine to achieve, is their one-part configuration. FIG. 4 shows a rotor 26 comprising eight multipolar annular magnets 20 with oriented flux. This configuration allows to eliminate the need for a support such as the support 24 described above and considerably reduces the number of magnets to be assembled.

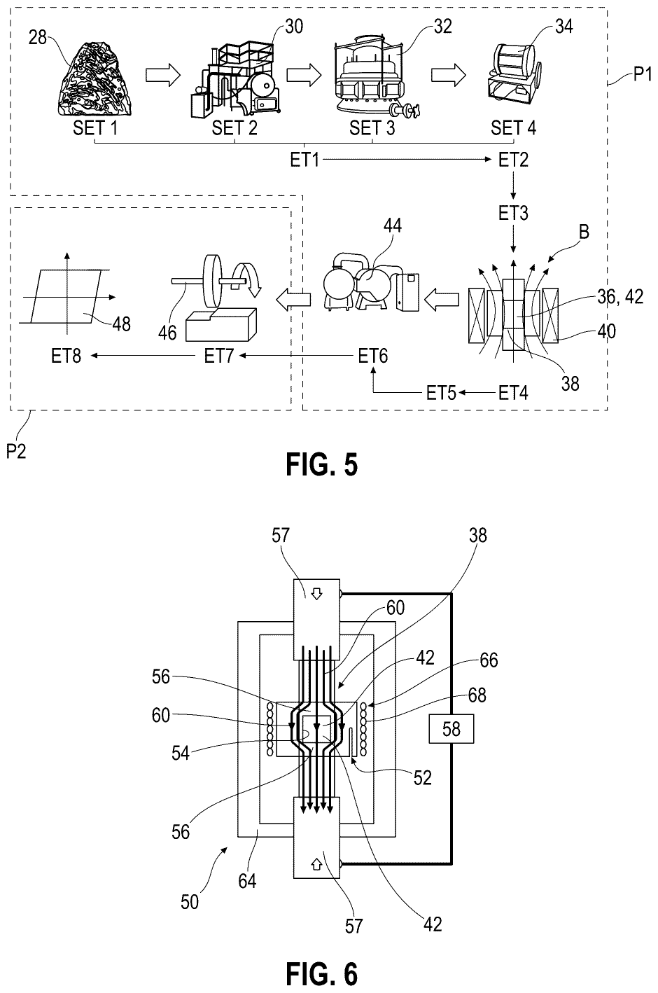

FIG. 5 illustrates the steps in a conventional method for producing a magnet 20. The method mainly comprises a first phase P1 of producing a magnet blank, and a second phase P2 of finishing the magnet blank.

The first phase P1 of producing the magnet blank comprises a first step ET1 during which metal magnet powders are supplied. This first step ET1 comprises a sub-step SET1 during which raw materials 28 such as Samarium Sm, Cobalt Co, Iron Fe, Copper Cu and Zirconium Zr are collected. Then the first step ET1 comprises a sub-step SET2 during which the raw materials 28 are melted in an induction furnace 30, then a sub-step SET3 during which they are ground in a grinding machine 32 until particles smaller than 500 μm are obtained and a sub-step SET4 during which they are pulverized in a ball milling or pressurized gas jet milling installation 34 until particles smaller than 10 μm are obtained.

Then, during a second step ET2, said powders are mixed, and during a third step ET3, the powders 36 are placed in a mold 38 and a first magnetization tool 40 is placed around this mold.

Then, during a fourth step ET4 of pressing under a magnetic field, the powders 36 are pressed at ambient temperature to obtain a magnet blank 42, and are simultaneously subjected to a magnetic field B generated by the first magnetization tool 36. The aim of this operation, while compacting them, is to orientate the powder grains in a preferential direction wherein subsequent definitive magnetization may be established more easily than in other directions. The result is a blank magnet 42.

Then, in a fifth step ET5, the magnetic field generated by the first magnetization tool is stopped, and in a sixth step ET6, the magnet blank 42 is densified by a conventional sintering method such as a furnace 44.

At the end of this first phase P1 of producing the magnet blank, the second phase P2 of finishing the magnet blank 42 takes place. This second phase P2 comprises at least one machining step ET7 of the magnet blank in a machining machine 46 and a final magnetization step ET8 of the magnet blank in a magnetization tool 48, to obtain the final magnet 20.

As we have already seen, in this method, the steps of pressing at ambient temperature ET4, densifying ET6 and final magnetization ET8 are dissociated and carried out in independent tools, which increases the complexity of the production range and generates long producing times in order to obtain a magnet 20.

The densifying step is typically carried out in a high-temperature chamber such as a furnace 44. The introduction of the magnet blanks 42 into the furnace 44 requires the latter to be initially at a temperature close to ambient temperature before it is brought up to temperature, which, given that densification itself is a long-term operation requiring several hours, results in a particularly long total immobilization time for the magnet blank 42 in the furnace.

The invention remedies this disadvantage by proposing a method wherein, during the third step ET3, the mold 38 is placed in a densifying chamber, this chamber being a particular chamber allowing, during the sixth step ET6 a flash sintering to be carried out in this densifying chamber.

Spark Plasma Sintering (SPS) is a pressure sintering method that uses the Joule effect to heat and densify powder particles. The powder to be sintered is placed in a graphite, steel or tungsten carbide matrix between two conductive electrodes, which also subject it to uniaxial pressure. A direct current of very high intensity, with successive pulses and a defined frequency, traverses the matrix, the electrodes and the powder, allowing a very rapid rise in temperature and a complete sintering in just a few minutes.

In practice, the steps ET3 to ET6 previously mentioned as taking place on the one hand in the mold 38 and on the other hand in the furnace 44 take place according to the method of the invention in a single device 50, the principle of which is shown in FIG. 6 in schematic form. This device 50 is used to form a cylindrical magnet blank 42.

In accordance with the invention, the device 50 comprises at least one metal mold 38 comprising a stationary matrix 52 delimiting a cavity 54 and at least one punch 56. The punch 56 is complementary to a section of the cavity 54, and is moved by an actuator 57 of a hydraulic press between a position outside the cavity 54 and a position wherein it closes the cavity and penetrates said cavity 54 along a predetermined path. Here, the device 50 has been represented as comprising two opposing punches 56, but this configuration is not restrictive of the invention.

The device 50 also comprise a flash SPS sintering tool comprising at least one pulsed current generator 58, current conducting means 60 arranged in the matrix 52 and the punches 56. Typically, these current conducting means are graphite-based conductors. The tool also comprises a densifying chamber 64 containing the mold 38, which may be selectively evacuated or filled with a neutral gas.

The device 50 comprises a first magnetization tool 66, comprising an annular magnetic circuit 68 housed in the chamber 64 and surrounding the mold 38. With the device 50, the powders with a particle size <10 μm (Samarium-Cobalt SmCo, Neodymium NdFeB, Ferrites or others) used during step ET3 to design a magnet may therefore be arranged. These powders are placed in the graphite or WC (tungsten carbides) or MAX phase ceramic (ternary carbides) mold 38, having the shape of the part to be produced with the punches 56 closing the cavity 54 of the mold. The magnetization tool 66 is positioned around the mold 38 and the assembly is placed in the densifying chamber 64. Then, during step ET4, the densifying chamber 64 is evacuated and the magnetic field produced by the first magnetizing tool 66 is applied. An increasing pressure of less than 100 MPa is then applied, without heating, by the punches 56 on the mold until the movement of the actuators 57 stops.

Once this state has been reached, the magnetic field is switched off following step ET5 and the atmosphere in the densifying chamber 64 is adapted by injecting a suitable atmosphere such as a neutral gas instead of a vacuum.

During step ET6, a pulsed current is supplied by the generator 58 to the mold 38 in order to rapidly raise the temperature to between 90° and 1200° C. and thus densify the powder. The stress exerted by the actuators 57 may be controlled during this step, by reducing it to 0 MPa and then increasing it again in different steps, independently. In any event, the pressure applied remains below 100 MPa. A temperature step is then applied for a period of 5 to 40 minutes until the powders are completely densified. This produces the magnet blank 42.

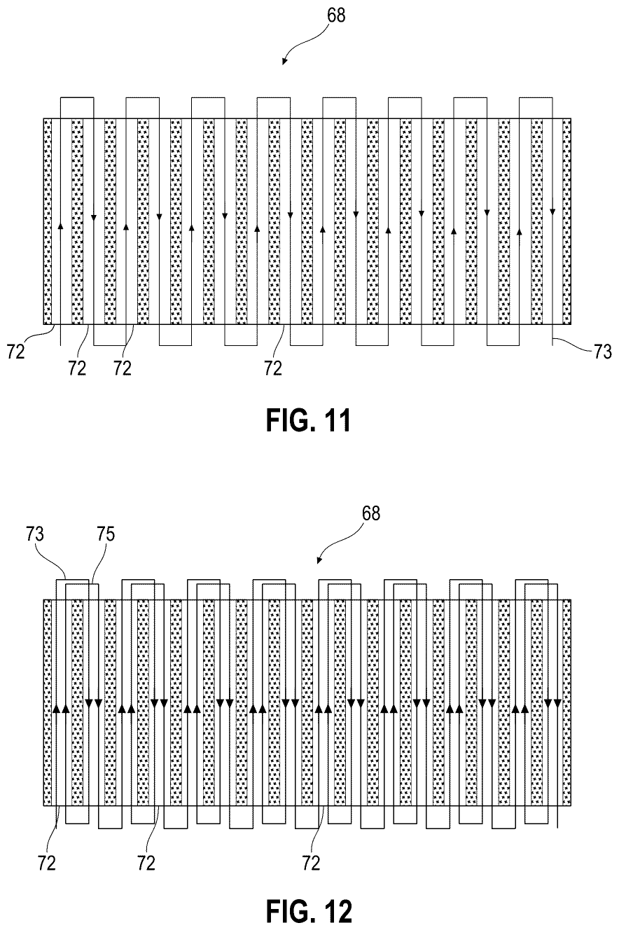

As shown in FIGS. 11 and 12, after this first phase P1 of producing the magnet blank 42 there is a second phase P2 of finishing the magnet blank 42 comprising at least one step of machining the magnet blank 42 and a step of final magnetization of the magnet blank 42, to obtain the magnet.

This second phase P2 may take place partly inside the device 50 or outside the device 50.

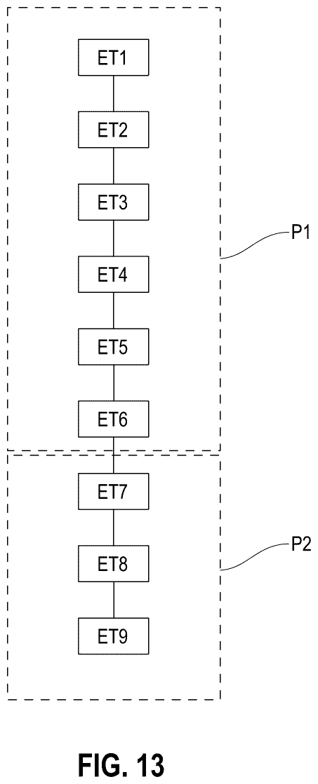

According to a first variant of the invention, as shown in FIG. 13, the second phase P2 of finishing the magnet blank 42 first comprises a seventh step ET7 during which the pressure exerted by the punches 56 is removed, the heating is switched off and the magnet blank 42 is allowed to cool to a Curie temperature of the magnet. The cooling temperature is controlled, for example, by a thermocouple inserted in the mold.

The Curie temperature depends on the nature of the powders 36 used. For example, this is 400 to 500° C. for ferrite Fe powders, 700 to 900° C. for Samarium-Cobalt SmCo powders and 300 to 400° C. for neodymium powders NdFeB.

In this first variant, the second phase P2 of finishing the magnet blank 42 then comprises an eighth step ET8 forming the final magnetization step during which the magnet blank 42 is again subjected to a magnetic field generated by the first magnetization tool 66.

This configuration is particularly advantageous as it allows the final magnetization of the magnet blank 42 in the device 50 to be carried out using the same first magnetization tool 66 previously employed. The magnet blank 42 therefore leaves the device 50 virtually ready for use, and it is therefore only necessary to finish it during a ninth step ET9 of machining the magnet blank 42 out of the mold 38, at the end of which the magnet 20 is obtained.

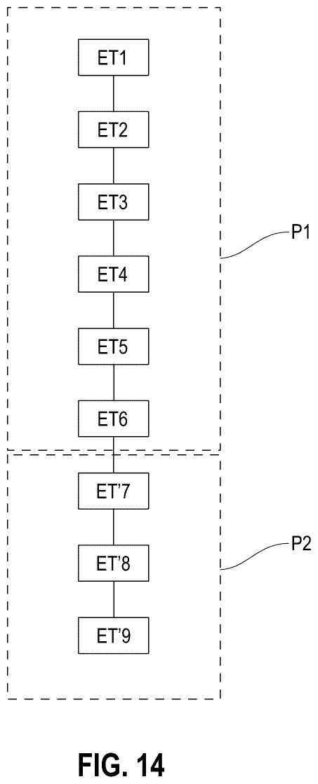

According to second and third variants of the invention, as shown in FIG. 14, the magnet blank 42 is extracted from the device 50 at the end of the first phase P1 and the second phase P2 of finishing the magnet blank 42 takes place outside the device 50, which advantageously allows to free the latter for the production of the next magnet blank 42.

In these second and third variants of the invention, the phase P2 of finishing the magnet blank 42 comprises a seventh step ET′7 of machining the magnet blank 42 out of the mold.

Then, during an eighth step ET′8, the magnet blank 42 is placed in a second magnetization tool (not shown) independent of the mold 38, in an orientation similar to a position occupied by the magnet blank 42 in the first magnetization tool 66 at the end of the fourth step ET4. The purpose of this arrangement is to orient the magnet blank 42 in accordance with the preferred direction wherein, during step ET4, the grains of the powder 42 have been previously oriented. As a reminder, this preferential direction makes it easier to establish definitive magnetization at a later date. Then, in a ninth step ET′9, the magnet blank 42 is magnetized by again subjecting the magnet blank 42 to a magnetic field generated by the second magnetization tool independent of the mold 38.

In the second variant of the method, the second magnetization tool is a specific magnetization tool dedicated to this task alone.

However, in the third variant of the method, the ninth step ET′9 may advantageously be carried out using, as a second magnetization tool independent of the mold, a stator of an electric machine configured to receive a rotor comprising the magnet. This configuration allows to dispense with a second specific magnetization tool and to magnetize the rotor magnet blank 42 in situ, directly in the electric machine.

A device 5) more particularly configured for the manufacture of a multipolar annular magnet 20 with oriented flux of axis X for a rotor of an electric machine of the electric motor, generator or sensor type is now described.

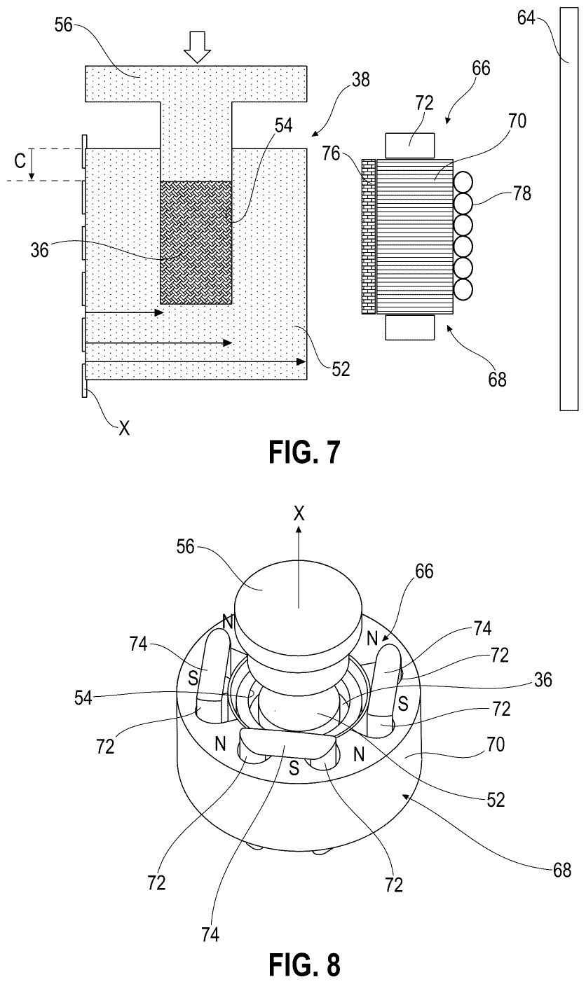

As before, the device 50 comprises at least one metal mold 38 comprising a stationary matrix 52 delimiting an annular cavity 54 of axis X configured to receive the powders 36 and at least one punch 56, also annular of axis X, which is therefore complementary to an annular section of the cavity 54. The punch is moved by an actuator of a hydraulic press (not shown in FIG. 7) between a position outside the cavity 54 and a position shown wherein it closes the cavity and enters the cavity 54 along a determined path C along the axis X, corresponding to the desired compaction of the powder 36. The device 50 shown in FIG. 6 comprises only one punch 56.

As before, the device 50 also comprises flash SPS sintering tool comprising at least one current generator and current conducting means (not shown) arranged in the matrix 52 and the punch 56. This tool allows a high intensity electric current to be traversed the powders 36 and their agglomeration by sintering.

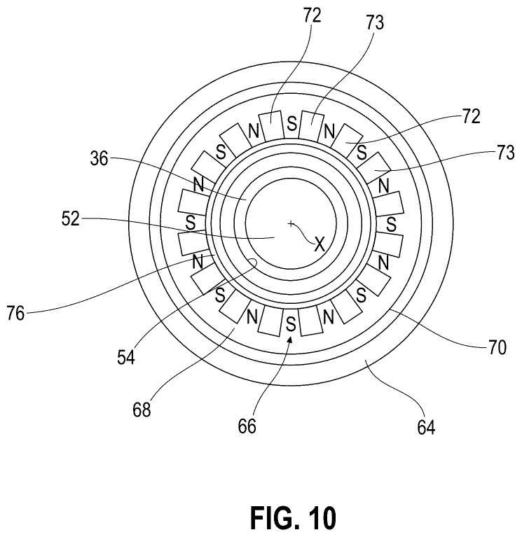

The tool also comprise a chamber 64 containing the mold 38, which has only been shown in FIGS. 7 and 10, and which, as before, may be selectively evacuated or filled with a neutral gas.

The device 50 comprises a first magnetization tool 66, comprising an annular magnetic circuit 68 housed in the chamber and surrounding the mold 38. This annular magnetic circuit comprises a substantially annular magnetic core 70 of axis X traversed by a plurality of magnetic coils 72 of axes parallel to the axis X and angularly distributed in a regular manner around the axis X.

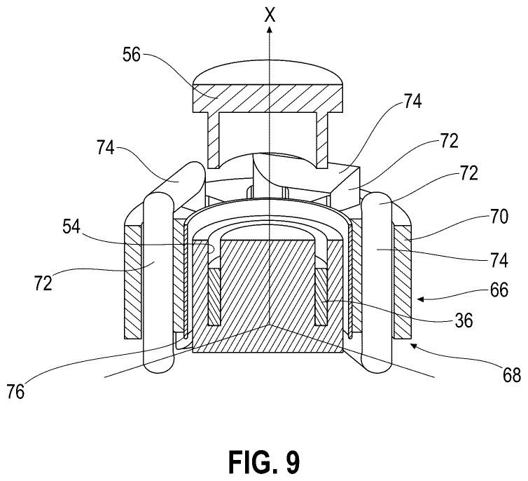

FIGS. 8 and 9 show a device 50 comprising a magnetic circuit 6) comprising eight magnetic coils 72 connected in series by transverse links 74, which allows to produce magnets with 8 poles (four North poles N and four South poles S) but it will be understood that, depending on the number of poles with which the magnet is to be equipped, the magnetic circuit may comprise a greater number of coils 72.

For example, as illustrated in FIG. 10, a device 50 according to the invention comprises a magnetic circuit 68 comprising 16 magnetic coils 72 allowing a magnet with 16 poles to be produced (eight North N poles and eight South S poles). The coils may comprise a magnetic circuit 68 of coils 72 comprising a single conductor 73, as illustrated by the layout of the magnetic circuit 68 in FIG. 11, or a magnetic circuit 68 of coils 72 comprising two conductors 73, 75 as illustrated by the layout of the magnetic circuit 68 in FIG. 12.

As shown in FIGS. 7, 9 and 10, the device 50 also comprises an annular heat shield 76 interposed between the mold and the magnetic circuit. This thermal shield allows to protect the coils 72 from the heat of the mold 38 when it is heated by the flash SPS sintering tool.

As shown in FIG. 7, the device 50 may also comprise an annular cooling exchanger 78 arranged around the magnetic circuit 68 inside the chamber 64. This configuration is more particularly suited to a device 50 configured to implement the first variant of the method described in the invention for which this annular cooling exchanger 78 allows to monitor and control the cooling temperature according to the first variant of the method described in the invention, between the seventh step ET7 and the eighth step ET8.

When it is configured to implement the second or third variants of the method covered by the invention, the device 50 is not used for the entire production of the magnet 20, since the final magnetization of the magnet blank 42 is performed outside the mold 38. In this case, the device is part of a magnet producing installation comprising the producing device described above and a second magnetization tool external to the device 50 (not shown). This second producing tool is similar in configuration to the first magnetization tool, and is able to surround the magnet blank 42. By similar tool, we mean in particular that this second magnetization tool comprises coils arranged in a similar way to the first magnetization tool 66, in order to maintain an orientation of the magnetic fields similar to those of the fields implemented during step ET4.

More particularly, when it is configured to implement the second variant of the method covered by the invention, the second external magnetization tool is substantially identical to the first external magnetization tool. When it is configured to implement the third variant of the method, no specific tool is involved, but simply a stator of an electric machine which is configured to accommodate a rotor receiving the magnet 20 with oriented flux. This configuration is highly advantageous because it allows to reduce the time the mold 38 is occupied by the magnet blank 42 in order to free it for other blanks, and allows the final magnetization of the magnet according to step ET′9 to be carried out directly in the electric machine.

The invention therefore allows to considerably reduce the production time of a multipole magnet with oriented flux for an electric machine rotor.

1. A method for producing a magnet for a rotor of an electric machine, said method comprising a first phase of producing a magnet blank comprising:
a first step during which metal and/or ceramic powders are supplied for the magnet,
a second step during which said powders are mixed,
a third step during which said powders are placed in a mold and a first magnetization tool is placed around said mold,
a fourth step of pressing under a magnetic field, during which said powders are pressed at room temperature to obtain the magnet blank, and are simultaneously subjected to a magnetic field generated by the first magnetization tool,
a fifth step during which the magnetic field generated by the first magnetization tool is stopped, and
a sixth step during which the magnet blank is densified,
said method further comprising a second phase for finishing the magnet blank comprising at least one step of machining the magnet blank and a step of final magnetization of the magnet blank, to obtain the magnet,
wherein during the third step, the mold is placed in a densifying chamber, in that the sixth step is carried out by flash SPS sintering in said densifying chamber.

2. The method according to claim 1, wherein the second phase of finishing the magnet blank comprises:
a seventh step during which the magnet blank is allowed to cool to a Curie temperature of the magnet,
an eighth step forming the final magnetization step during which the magnet blank is again subjected to a magnetic field generated by the first magnetization tool, and
a ninth step of machining the magnet blank out of the mold, at the end of which the magnet is obtained.

3. The method according to claim 1, wherein the second phase of finishing the magnet blank comprises:
a seventh step of machining the magnet blank out of the mold,
an eighth step during which the magnet blank is arranged in a second magnetization tool independent of the mold in an orientation similar to a position occupied by the magnet blank in the first magnetization tool at the end of the fourth step, and
a ninth step forming the final magnetization step, during which the magnet blank is again subjected to a magnetic field generated by the second magnetization tool independent of the mold.

4. The method according to claim 3, wherein the ninth step is carried out using a stator of an electric machine as a second magnetization tool independent of the mold.

5. The method according to claim 1, wherein during the fourth step of pressing under a magnetic field, the powders are pressed under an increasing pressure of less than 100 MPa.

6. The method according to claim 1, wherein during the sixth step, the powder is densified by rapidly raising its temperature to between 90° and 1200° C.

7. A device for implementing the producing method according to claim 1, the device comprising:
a metal mold comprising a stationary matrix delimiting a cavity and at least one punch which is complementary to a section of the cavity, and which is moved by a hydraulic press between a position outside the cavity and a position wherein the at least one punch closes off the cavity and penetrates into said cavity along a predetermined path,
a flash SPS sintering tool comprising at least one pulsed current generator, current conducting means arranged in said matrix and said punch, and a chamber containing the mold capable of being selectively evacuated or filled with a neutral gas, and
a first magnetization tool, comprising an annular magnetic circuit housed in the chamber and surrounding the mold.

8. The device according to claim 7, further comprising an annular heat shield interposed between the mold and the magnetic circuit.

9. The device according to claim 7, further comprising an annular cooling exchanger arranged around the magnetic circuit inside the chamber.

10. The device according to claim 7, wherein the device is configured for the production of a multipolar annular magnet with a flux oriented along the axis, and wherein:
the cavity of the mold is annular with axis,
the annular magnetic circuit of the first magnetization tool comprises a substantially annular magnetic core traversed along axis by a plurality of magnetic coils having axes parallel to the axis and distributed angularly in a regular manner about said axis.

11. The device according to claim 10, wherein the magnetic core is traversed by a number of magnetic coils of between 4 and 16.

12. The device according to claim 7, wherein the mold is made of graphite or based on tungsten carbides or ternary carbides.

13. The device according to claim 7, wherein the current conducting means are graphite conductors.

14. An installation for producing a multipolar annular magnet with flux oriented along the axis in accordance with a method for producing a magnet for a rotor of an electric machine, said method comprising a first phase of producing a magnet blank comprising:
a first step during which metal and/or ceramic powders are supplied for the magnet,
a second step during which said powders are mixed,
a third step during which said powders are placed in a mold and a first magnetization tool is placed around said mold,
a fourth step of pressing under a magnetic field, during which said powders are pressed at room temperature to obtain the magnet blank, and are simultaneously subjected to a magnetic field generated by the first magnetization tool,
a fifth step during which the magnetic field generated by the first magnetization tool is stopped,
a sixth step during which the magnet blank is densified,
said method further comprising a second phase for finishing the magnet blank comprising at least one step of machining the magnet blank and a step of final magnetization of the magnet blank, to obtain the magnet,
a seventh step of machining the magnet blank out of the mold,
an eighth step during which the magnet blank is arranged in a second magnetization tool independent of the mold in an orientation similar to a position occupied by the magnet blank in the first magnetization tool at the end of the fourth step, and
a ninth step forming the final magnetization step, during which the magnet blank is again subjected to a magnetic field generated by the second magnetization tool independent of the mold,
wherein during the third step, the mold is placed in a densifying chamber, in that the sixth step is carried out by flash SPS sintering in said densifying chamber,
the installation further comprising a producing device according to claim 8 and a second magnetization tool external to said producing device and of similar configuration to the first magnetization tool, able to surround the magnet blank.

15. The installation according to claim 14, wherein the second magnetization tool is a stator of an electric machine, a rotor of which is configured to receive the magnet with oriented flux.
